(19) United States
(12) Patent Application Publication
(10) Pub. No.: US 2008/0278463 A1
(43) Pub. Date: Nov. 13, 2008

(54) Driving Device and Related Source Driver of a Flat Panel Display

(76) Inventor: Po-Tsun Chen, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/779,273

(22) Filed: Jul. 17, 2007

(30) Foreign Application Priority Data
May 10, 2007 (TW) 096116674

(51) Int. Cl. G06F 3/038

(52) U.S. Cl. 345/204

(57) ABSTRACT

A driving device of a flat panel display includes a scan-line-signal output circuit for outputting gate driving signals to a display panel of the flat panel display, and a data-line-signal output circuit including a plurality of source drivers for outputting a plurality of source driving signals to the display panel. Each source driver includes an interface reception unit for receiving video signals and generating corresponding image data and control signals, an image transformation unit for generating a source driving signal to the display panel according to image data, a timing control unit for controlling timing of the source driving signal outputted from the image transformation unit, and a logic unit for controlling factors the source driving signal outputted from the image transformation unit by controlling the image transformation unit and the timing control unit.

### BACKGROUND OF THE INVENTION

1. Field of the Invention

The present invention is a driving device and related source drivers used in a flat panel, and more specifically, a driving device capable of reducing production costs and is applicable to large-sized or high-resolution display panels.

2. Description of the Prior Art

The advantages of a liquid crystal display (LCD) include lighter weight, less electrical consumption, and less radiation contamination. Thus, the LCD monitors have been widely applied to various portable information products, such as laptops, mobile phones, PDAs, etc. In an LCD monitor, incident light produces different polarization or refraction effects when the alignment of liquid crystal molecules is altered. The transmission of the incident light is affected by the liquid crystal molecules, and thus magnitude of the light emitting out of liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1, which illustrates a schematic diagram of a prior art thin film transistor (TFT) LCD monitor 10. The LCD device 10 includes an LCD Panel 12 and a driving device 14. The LCD panel 12 is composed of two substrates with LCD layers filled between, and the circuit property can be seen as an equivalent capacitor. Besides, data lines and scan lines are set on columns and rows of the LCD panel 12. Each intersection of a data line and a scan line is connected to a TFT. FIG. 1 shows only 4 of the TFTs. The driving device 14 includes a timing control circuit 102, a data-line-signal output circuit 104, and a scan-line-signal output circuit 106. The data-line-signal output circuit 104 and the scan-line-signal output circuit 106 output signals to data lines and scan lines according to control signals outputted from the timing control circuit 102, so as to control specific TFTs.

The following is the theorem of the driving device 14 driving the LCD panel 12 to display frames. According to image data, the timing control circuit 102 generates corresponding control signals for the data-line-signal output circuit 104 and the scan-line-signal output circuit 106 respectively. Then, the data-line-signal output circuit 104 and the scan-line-signal output circuit 106 generate input signals for different data lines and scan lines according to the control signals, so as to control transmissions of corresponding TFTs and voltage differences between two ends of the equivalent capacitor, and further change the liquid crystal array and the transmission of the incident light, in order to control the grey level of corresponding pixels, and display the data on the panel.

In FIG. 1, the data-line-signal output circuit 104 and the scan-line-signal output circuit 106 are presented in blocks. In fact, as shown in FIG. 2, in applications of large-size or high-resolution display panels, the data-line-signal output circuit 104 is composed of source drivers CD_1˜CD_n corresponding to specific data lines respectively, for outputting corresponding signals to the data lines according to the control signals outputted from the timing control circuit 102. The source drivers CD_1˜CD_n are connected in a series, for exchanging signals such as DIO1, DIO2, LD, POL, etc, so as to control properties, such as data output directions (from CD_1 to CD_n or from CD_n to CD_1), timings, polarities, etc. Under this condition, besides signal lines, each source driver must include a plurality of pins, so as to exchange related signals with adjacent source drivers, which increases production cost.

Certainly, in order to solve the above-mentioned problem, the source drivers CD_1˜CD_n and the timing control circuit 102 are integrated into a chip. However, this practice limits the image quality, and is therefore applicable to small-size or low-resolution display panels.

### SUMMARY OF THE INVENTION

It is therefore a primary objective of the claimed invention to provide a driving device and related source drivers of a flat panel display.

The present invention discloses a driving device of a flat panel display, comprising a scan-line-signal output circuit for outputting gate driving signals to a display panel of the flat panel display, and a data-line-signal output circuit comprising a plurality of source drivers for outputting a plurality of source driving signals to the display panel, each of the plurality of source drivers comprising an interface reception unit for receiving image and video standard interface signals and generating corresponding image data and control signals, an image data transformation unit for generating source driving signals to the display panel according to the image data generated from the interface reception unit, a timing control unit for controlling a timing sequence of the source driving signals outputted from the image transformation unit according to the control signals generated from the interface reception unit, and a logic unit for controlling factors of the source driving signals outputted from the image transformation unit by controlling the image transformation unit and the timing control unit.

The present invention further discloses a source driver of a flat panel, for outputting a plurality of source driving signals to a display panel of the flat panel, the source driver comprising an interface reception unit for receiving image and video standard interface signals and generating corresponding image data and control signals, an image data transformation unit for generating source driving signals to the display panel according to the image data generated from the interface reception unit, a timing control unit for controlling a timing sequence of the source driving signals outputted from the image data transformation unit according to the control signals generated from the interface reception unit, and a logic unit for controlling factors of the source driving signals outputted from the image transformation unit by controlling the image transformation unit and the timing control unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art thin film transistor liquid crystal display monitor.

FIG. 2 illustrates a schematic diagram of a data-line-signal output circuit shown in FIG. 1.

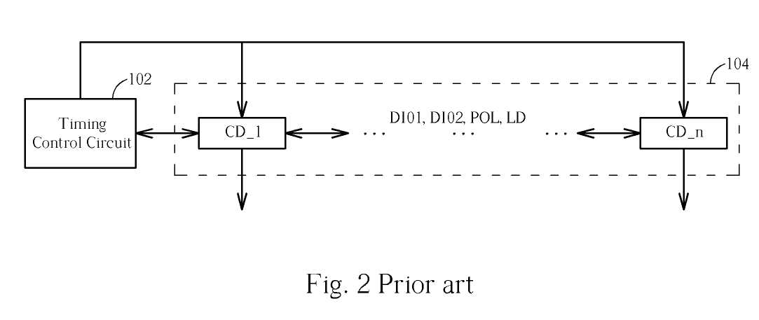

FIG. 3 illustrates a schematic diagram of a driving device according to a preferred embodiment of the present invention.

FIG. 4 illustrates a diagram of the source driver shown in FIG. 3.

### DETAILED DESCRIPTION

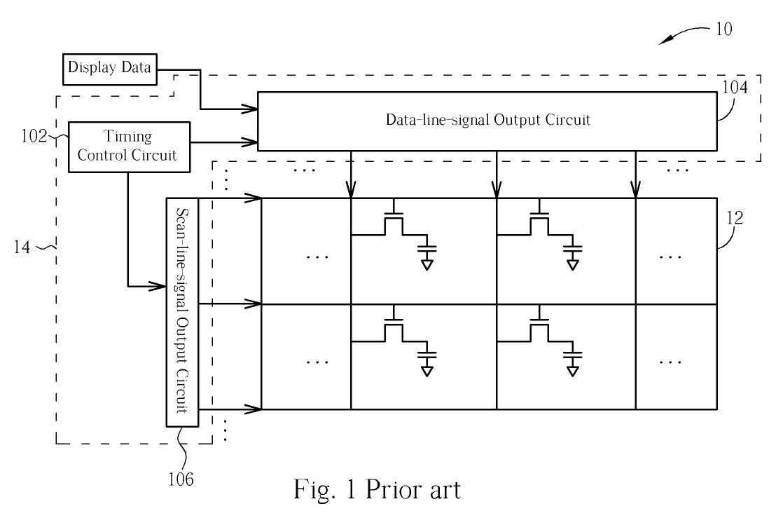

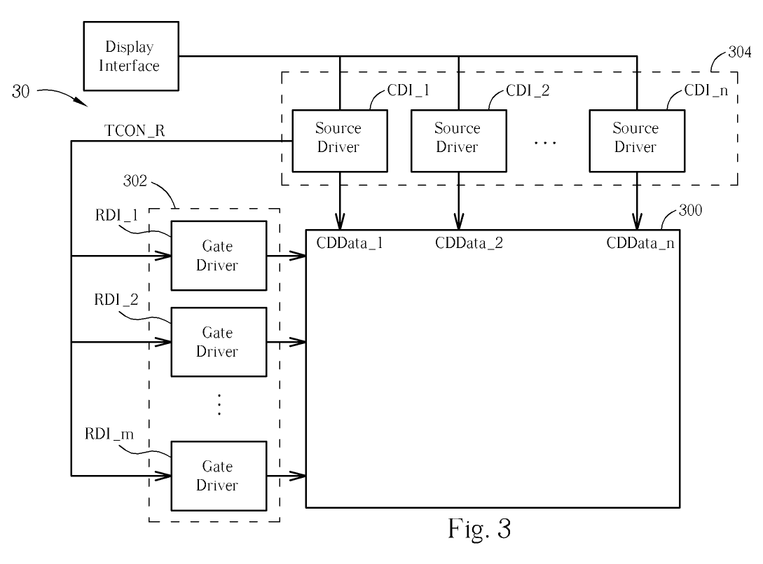

Please refer to FIG. 3, which illustrates a schematic diagram of a driving device 30 according to a preferred embodiment of the present invention. The driving device 30 drives a display panel 300, and the structure of the display panel 300 is the same as the LCD panel 12 shown in FIG. 1, which will not be narrated in detail. The driving device 30 includes a scan-line-signal output circuit 302 and a data-line-signal output circuit 304, which are utilized for receiving image signals through a display interface to display pictures on the display panel 300. The scan-line-signal output circuit 302 includes gate drivers RDI_1˜RDI_m, which are utilized for outputting gate driving signals to scan lines of the display panel 300. The data-line-signal output circuit 304 includes source drivers CDI_1˜CDI_n corresponding to specific data lines respectively. The source drivers CDI_1˜CDI_n are utilized for outputting source driving signals CDData_1˜CDData_n to the display panel 300 according to the image signals received by the display interface. The structures of the source drivers CDI_1˜CDI_n are all the same, while in this embodiment, the source driver CDI_1 is a primary source driver, which outputs a control signal TCON_R to the gate drivers RDI_1˜RDI_m, to control the gate drivers RDI_1˜RDI_m.

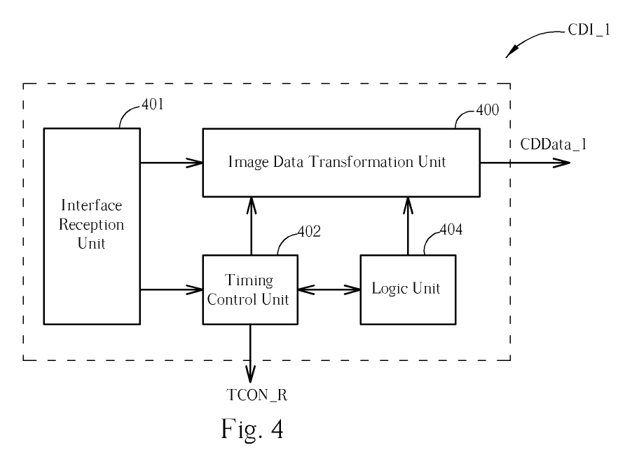

Please refer to FIG. 4, which illustrates a diagram of the source driver CDI_1 shown in FIG. 3. The source driver CDI_1 includes an interface reception unit 401, an image data transformation unit 400, a timing control unit 402, and a logic unit 404. The interface reception unit 401 receives low voltage differential signals (LVDS), Red, Green, Blue (RGB) or CCIR601/656 video signals, so as to generate the corresponding image data and control signals. The image data transformation unit 400 is utilized for receiving and processing the image data generated by the interface reception unit 401, so as to generate the source driving signal CDData_1. The timing control unit 402 controls the timing of the source driving signal CDData_1 generated from the image data transformation unit 400 according to the control signals generated by the interface reception unit, and outputs the control signal TCON_R to the gate drivers RDI_1˜RDI_m. The logic unit 404 controls the image data transformation unit 400 and the timing control unit 402, so as to control properties of the source driving signal CDData_1, such as data output directions, timings, polarities, etc. Furthermore, structures of the source drivers CDI_2˜CDI_n are completely the same as the structure of the source driver CDI_1 shown in FIG. 4, while timing control units of the source drivers CDI_2˜CDI_n do not output signals to the gate drivers RDI_1˜RDI_m.

In the data-line-signal output circuit 304, each source driver includes an image data transformation unit for processing the image data, a timing control unit for executing the timing control function, and a logic unit for controlling the image data transformation unit and the timing control unit. Hence, each of the source drivers CDI_1˜CDI_n is connected to a corresponding data line independently, and can control properties, such as directions, timings, polarities, of data outputted from the image data transformation unit with the logic unit and the timing control unit, so that exchange of signals, such as DIO1, DIO2, LD, POL, etc., is not required. Under this condition, in addition to saving signal line costs, pins required for the source drivers CDI_1˜CDI_n can also be reduced, so as to lower the production cost. Moreover, The source drivers CDI_1˜CDI_n can process image data separately, making the driving device 30 applicable to large-size or high-resolution display panels.

Note that, the driving device 30 shown in FIG. 3 is merely an exemplary embodiment of the present invention, and those skilled in the art can make modifications accordingly. For example, in FIG. 3, the source driver CDI_1 is the primary source driver, which means that the control signal TCON_R is outputted from the timing control unit 402 of the source driver CDI_1. In practice, any of the source drivers CDI_2˜CDI_n can be set as a primary source driver, and control the timing control unit to output the control signal TCON_R to the gate drivers RDI_1˜RDI_m through the corresponding logic unit. Certainly, to prevent the image quality from being affected by factors such as abnormal unplugs, low signal quality, etc., the source drivers CDI_1˜CDI_n can also be connected in a series, and exchange the polarity control signal POL, so as to enhance the image quality.

As a conclusion, in the driving device 30 of the present invention, each source driver includes an image data transformation unit for processing the image data, a timing control unit for executing the timing control function, and a logic unit for controlling the image data transformation unit and the timing control unit. Hence, each source driver connects to the corresponding data line independently, which not only cuts costs of the signal lines, but also decreases the need of pins, to lower the production cost, and is also applicable to large-size or high-resolution display panels.

Those skilled in the art will readily observe that numerous modifications and alterations of the device and method may be made while retaining the teachings of the invention.

What is claimed is:

1. A driving device of a flat panel display comprising:
a scan-line-signal output circuit for outputting gate driving signals to a display panel of the flat panel display; and
a data-line-signal output circuit comprising a plurality of source drivers for outputting a plurality of source driving signals to the display panel, each of the plurality of source drivers comprising:
an interface reception unit for receiving image and video standard interface signals and generating corresponding image data and control signals;
an image data transformation unit for generating source driving signals to the display panel according to the image data generated from the interface reception unit;
a timing control unit for controlling a timing sequence of the source driving signals outputted from the image transformation unit according to the control signals generated from the interface reception unit; and
a logic unit for controlling factors of the source driving signals outputted from the image transformation unit by controlling the image transformation unit and the timing control unit.

2. The driving device of claim 1, wherein the data-line-signal output circuit comprises a main source driver, for controlling a timing sequence of the gate driving signals outputted from the scan-line-signal output circuit.

3. The driving device of claim 2, wherein the main source driver is one of the plurality of source drivers.

4. The driving device of claim 3, wherein the main source driver controls the timing sequence of the gate driving signals outputted from the scan-line-signal output circuit through a timing control unit of the main source driver.

5. The driving device of claim 3, wherein the main source driver is a source driver nearest to the scan-line-signal output circuit in the plurality of source drivers.

6. The driving device of claim 3, wherein the logic unit of each source driver is further utilized for determining whether a corresponding source driver is the main source driver.

7. The driving device of claim 1, wherein the logic unit controls polarities, positions and directions, corresponding to the display panel, of the source driving signals outputted from the image data transformation unit.

8. The driving device of claim 1, wherein the plurality of source drivers are connected in a sequence.

9. The driving device of claim 1, wherein the scan-line-signal output circuit comprises a plurality of gate drivers connected in a sequence.

10. The driving device of claim 1, wherein the image and video standard interface signals are standard interface signals of LVDS (Low Voltage Differential Signal), RGB (Red, Green, Blue) or CCIR601/656.

11. A source driver of a flat panel, for outputting a plurality of source driving signals to a display panel of the flat panel, the source driver comprising:
an interface reception unit for receiving image and video standard interface signals and generating corresponding image data and control signals;
an image data transformation unit for generating source driving signals to the display panel according to the image data generated from the interface reception unit;
a timing control unit for controlling a timing sequence of the source driving signals outputted from the image data transformation unit according to the control signals generated from the interface reception unit; and
a logic unit for controlling factors of the source driving signals outputted from the image transformation unit by controlling the image transformation unit and the timing control unit.

12. The source driver of claim 11, wherein the logic unit controls polarities, positions and directions, corresponding to the display panel, of the source driving signals outputted from the image data transformation unit.

13. The source driver of claim 11, wherein the image and video standard interface signals are standard interface signals of LVDS (Low Voltage Differential Signal), RGB (Red, Green, Blue) or CCIR601/656.
